(19) United States
(12) Patent Application Publication
(10) Pub. No.: US 2023/0140789 A1
(43) Pub. Date: May 4, 2023

(54) ROBUST NETWORK CONNECTIVITY LEVERAGING EDGE COMPUTE

(71) Applicant: Level 3 Communications, LLC, Broomfield, CO (US)

(72) Inventor: Kevin WENZEL, Tyron, NC (US)

(73) Assignee: Level 3 Communications, LLC, Broomfield, CO (US)

(21) Appl. No.: 17/823,993

(22) Filed: Sep. 1, 2022

Related U.S. Application Data
(60) Provisional application No. 63/275,024, filed on Nov. 3, 2021.

(51) Int. Cl. H04L 41/0663; H04L 43/0817; H04L 12/46; H04L 61/2514

(52) U.S. Cl. CPC H04L 41/0663; H04L 43/0817; H04L 12/4633; H04L 61/2514

(57) ABSTRACT

The present disclosure describes providing robust network connectivity by creating a virtual overlay network over a plurality of communication network channels, such that if there is a failover on a first network, a failover overlay tunnel may be used to prevent an interruption in service when the first network drops. An SD-WAN remote may be deployed at an edge location of a network and an SD-WAN base may be installed at a client premises. A first overlay tunnel using a first communication transport may be utilized as a default route and a second overlay tunnel using a second communication transport may be used as a failover route.

### CROSS-REFERENCE TO RELATED APPLICATIONS

This application claims the benefit of U.S. Provisional Application No. 63/275,024, filed on Nov. 3, 2021, entitled “Robust Network Connectivity Leveraging Edge Compute,” which is incorporated herein by reference in its entirety.

### BACKGROUND

Connectivity to a network can be susceptible to service interruptions and outages. In some locations, some communication transports may be less reliable than in other locations. Such interruptions and outages may be caused by various factors, such as obstructions (e.g., satellite), cut cables, technology/device failures, natural disasters, cyber-attacks, etc. It is desirable to prevent an interruption or disconnection of network connectivity from causing an interruption or disconnection of network service to devices operating at a client premises. As one illustrative example, a user of a computing device (e.g., desktop device, mobile device, laptop device, gaming device) may utilize the device for real time services, such as Voice over Internet Protocol (VoIP), video communicating, online gaming, etc., and may rely on consistent network connectivity for that service. An interruption or disconnection of network service during a web a real time session, for example, may cause the session to disconnect. As can be appreciated, this can be particularly disrupting and frustrating to users, and may not meet the networking needs of the users.

### SUMMARY

The present disclosure describes a system and method for providing robust network connectivity by creating a virtual overlay network over a plurality of communication network channels. If there is a failover on a first network, a failover overlay tunnel may be used to prevent an interruption in service when the first network drops.

Accordingly, in some examples, the present disclosure describes a system for providing robust network connectivity, the system comprising: a software-defined wide area network (SD-WAN) remote implemented at an edge location of a network, wherein the SD-WAN remote is operative to: communicate with an SD-WAN base implemented at a client premises over a first overlay tunnel created via a first access network; communicate with the SD-WAN base over a second overlay tunnel created via a second access network, wherein the first overlay tunnel is prioritized over the second overlay tunnel by default; receive a first outbound communication from the SD-WAN base over the first overlay tunnel; translate a source address of the first outbound communication from a first Internet protocol (IP) address of the SD-WAN base to an IP address of the SD-WAN remote; direct the first outbound communication to a destination device; receive a first inbound communication from the destination device; translate the destination address of the first inbound communication from the IP address of the SD-WAN remote to the first IP address of the SD-WAN base; direct the first inbound communication to the SD-WAN base over the first overlay tunnel; and after a failover event is determined in association with the first overlay tunnel: receive a second outbound communication from the SD-WAN base over the second overlay tunnel; translate a source address of the second outbound communication from a second IP address of the SD-WAN base to the IP address of the SD-WAN remote; and direct the second outbound communication to the destination device.

In some examples, the present disclosure describes a method for providing robust network connectivity, comprising: establishing a first overlay tunnel over a first communication transport with an SD-WAN base implemented at a client premises; establishing a second overlay tunnel over a second communication transport with the SD-WAN base; advertising the first overlay tunnel with a higher priority than the second overlay tunnel by default; receiving a first outbound communication from the SD-WAN base over the first overlay tunnel; translating a source address of the first outbound communication from a first IP address of the SD-WAN base to an IP address of the SD-WAN remote; directing the first outbound communication to a destination device; receiving a first inbound communication from the destination device; translating the destination address of the first inbound communication from the IP address of the SD-WAN remote to the first IP address of the SD-WAN base; directing the first inbound communication to the SD-WAN base over the first overlay tunnel; and after a failover event is determined in association with the first overlay tunnel: receiving a second outbound communication from the SD-WAN base over the second overlay tunnel; translating a source address of the second outbound communication from a second IP address of the SD-WAN base to the IP address of the SD-WAN remote; and directing the second outbound communication to the destination device.

In some examples, the present disclosure describes a system for providing robust network connectivity, the system comprising: an SD-WAN base implemented at a client premises, wherein the SD-WAN base is operative to: establish a first overlay tunnel created over a first communication transport with an SD-WAN remote implemented an edge location of a network; establish a second overlay tunnel created over a second communication transport with the SD-WAN remote, wherein the first overlay tunnel is prioritized over the second overlay tunnel by default; receive an outbound communication from a connected device; determine whether the first overlay tunnel is stable or whether a failover event has occurred; when the first overlay tunnel is determined to be stable: forward the outbound communication to the SD-WAN remote over the first overlay tunnel; and when a failover event is determined to have occurred: forward the outbound communication to the SD-WAN remote over the second overlay tunnel.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following figures.

FIG. 1 is an example operating environment including an example edge-based connectivity failover system for providing robust network connectivity.

FIG. 2 is an example sequence diagram illustrating an example sequence of communications that may be exchanged between various components that may operate in the example edge-based connectivity failover system of FIG. 1.

FIG. 3 is a flowchart illustrating operations of an example method for providing robust network connectivity according to an embodiment.

FIG. 4 is a flowchart illustrating operations of an example method for providing robust network connectivity according to another embodiment.

FIG. 5 is a flowchart illustrating operations of an example method for providing robust network connectivity according to another embodiment.

FIG. 6 is a block diagram of a computing device with which one or more aspects of the disclosure may be implemented.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems or devices. Accordingly, examples may take the form of a hardware implementation, an entirely software implementation, or an implementation combining software and hardware aspects. The following detailed description is therefore not to be taken in a limiting sense, and the scope of the present disclosure is defined by the appended claims and their equivalents.

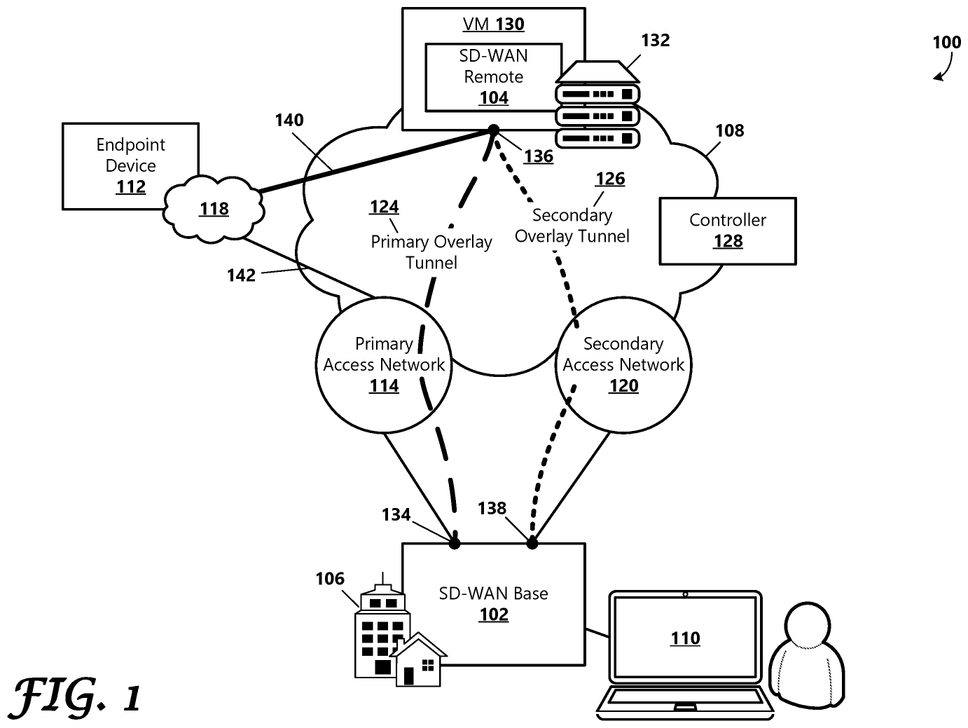

The present disclosure describes an edge-based connectivity failover system and process that can be used to create a virtual overlay network over a plurality of communication network channels to provide continuous network connectivity, thus preventing an interruption in service and a communication session. These and other examples will be explained in more detail below with respect to FIGS. 1-6. It will be appreciated that the examples shown by the figures and described herein may be used across the various implementations described herein.

FIG. 1 is a schematic diagram illustrating a networked computing environment in which an edge-based connectivity failover system 100 may be implemented for providing robust network connectivity according to an example. In general, the edge-based connectivity failover system 100 may include a software-defined wide area network (SD-WAN) base 102 implemented at a client premises 106 and an SD-WAN remote 104 implemented at an edge location of an Internet protocol (IP) based wide area network (herein referred to as network 108), such as the Internet. The network 108, for example, may provide various services to customers of the network, including transmission of communications between network devices, network services, network computing environments, cloud services, such as storage services, networking service, compute services, and the like. To provide such services, various networking components and other devices may be interconnected and configured within the network 108 such that customers may access network devices and/or other networks 118 (e.g., a core service-provider network).

In some examples, robust network connectivity may be provided as a service by the network service provider, such as the service provider of the network 108. When a customer of the network 108 is provisioned to receive robust network connectivity service, an SD-WAN remote 104 instance may be deployed at an edge location of the network 108 such that a plurality of secure overlay tunnels may be created between the SD-WAN base 102 and the SD-WAN remote 104 over a plurality of communications transports. For example, a first overlay tunnel may be utilized as a default route and a second overlay tunnel may be used as a failover route.

For example, the edge location may include a physical edge device 132 located between the network 108 and an endpoint device 112, e.g., that may be accessible via another network 118 (e.g., the core service-provider network). The edge device 132, for example, may be comprised of a server stack onto which at least one virtual machine (VM) 130 may be set up to run and host the SD-WAN remote 104. In some examples, the SD-WAN remote 104 may operate to securely and intelligently direct traffic between the network 108 and an endpoint device 112, e.g., that may be accessible via other networks 118. In some examples and as will be described in further detail below, the SD-WAN remote 104 may act as an agent between the SD-WAN base 102 and other networks 118, wherein a single IP address may represent outgoing network traffic received from the SD-WAN base 102 regardless of which secure overlay tunnel the SD-WAN base 102 uses to transmit the outgoing network traffic to the SD-WAN remote 104.

In some examples, the SD-WAN remote 104 may be programmed to direct traffic across the network 108 based on a set of predefined rules. When robust network connectivity service is provisioned to a customer, a controller 128 may operate to instantiate the SD-WAN remote 104 and configure the SD-WAN remote 104 to communicate with a SD-WAN base 102 installed at the customer's premises (i.e., client premises 106). In some examples, the controller 128 may be configured provide a template to the SD-WAN remote 104 and to the SD-WAN base 102, wherein the template may include the set of predefined rules. The template, in some examples, may be customized for the customer. The controller 128 may additionally provide IP addresses and authentication and encryption information to the SD-WAN remote 104 and the SD-WAN base 102 that may allow the SD-WAN remote 104 and the SD-WAN base 102 to establish secure overlay tunnels over a plurality of communications transports. For example, a first overlay tunnel may be utilized as a default route and a second overlay tunnel may be used as a failover route. In other implementations, additional overlay tunnels may be created over one or more additional communications transports.

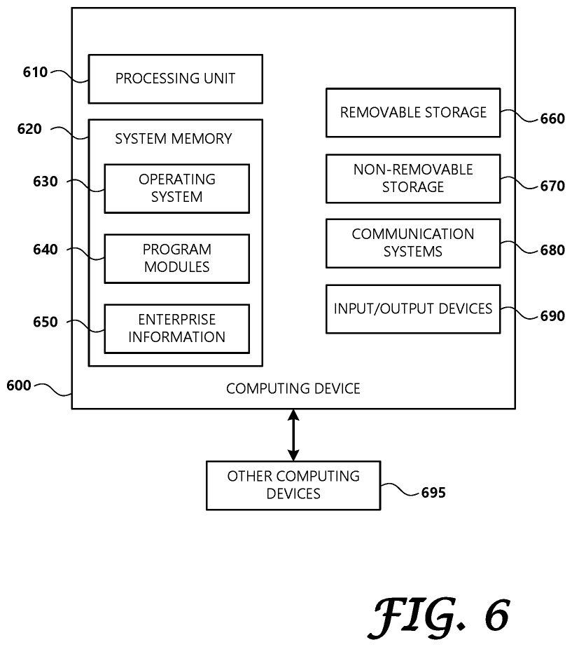

In some examples, when a customer of the network 108 is provisioned to receive robust network connectivity service, the SD-WAN base 102 may be provided to the customer to be installed at the client premises 106. In one example implementation, the SD-WAN base 102 may be a hardware device, such as the example computing device described below with reference to FIG. 6, wherein the SD-WAN base 102 may comprise at least one processor and a memory storage device including instructions, that when executed by the at least one processor, are configured to perform various functionalities as described herein for providing robust network connectivity. In another example implementation, the SD-WAN base 102 may be a software application that can be executed by a computing device, which includes sufficient computer executable instructions that are operative or configured to perform various functionalities as described herein for providing robust network connectivity.

The SD-WAN base 102, for example, may operate to connect one or more devices 110 at the client premises 106 to an access network (e.g., primary access network 114). The devices 110, for example, may include various computing devices (e.g., mobile computing devices, laptop computers, desktop computers, servers, gaming devices, set-top boxes) and/or other Internet-of-Things (IOT) and smart devices. For example, the SD-WAN base 102 may be configured to operate as a gateway (e.g., a modem connected to a router, a modem and router) to the primary access network 114. The primary access network 114 may include various telecommunications network delivery connections and components that may link customers (e.g., client premises 106 or a device 110 at the client premises 106) to the network 108. In some examples, the primary access network 114, for example, may be an access network typically utilized by default at the client premises 106 to provide Internet (e.g., network 108) service to connected devices 110. For example, primary access network 114 may comprise one or more network provided by a broadband Internet service provider, such as a cable network provider, fiber-optic network provider, telecommunications network provider, fixed-wireless network provider, etc.

As shown in FIG. 1, the client premises 106 may additionally have access to the network 108 via a secondary access network 120. In some examples, the secondary access network 120 may comprise one or more communication network(s) provided by a wireless communications provider. In nonexclusive examples, the primary access network 114 and/or the secondary access network 120 may employ one or more of a variety of data transport, routing, and communications protocols and technologies, including TCP/IP, Multiprotocol Label Switching (MPLS), 4G, 5G, Long-Term Evolution (LTE), digital subscriber line service (DSL), fixed wireless service, terrestrial wireless service, satellite service, or other wired or wireless local exchange carrier-provided service). Other example primary and secondary access network and communication standards, protocols, and other technologies are possible and are within the scope of the present disclosure.

In some examples, network connectivity can be susceptible to service interruptions and outages. In some locations, some communication transports may be less reliable than in other locations. Such interruptions and outages may be caused by various factors, such as obstructions (e.g., satellite), cut cables, technology/device failures, natural disasters, cyber-attacks, etc. It is desirable to prevent an interruption or disconnection of network connectivity via the primary access network 114 from causing an interruption or disconnection of network service to devices 110 operating at the client premises 106. As one illustrative example, a user of a computing device 110 (e.g., desktop device, mobile device, laptop device, gaming device) may utilize the device for real time services, such as Voice over Internet Protocol (VoIP), video communicating, online gaming, etc., and may rely on consistent network connectivity for that service. An interruption or disconnection of network service during a real time web session, for example, may cause the session to disconnect. As can be appreciated, this can be particularly disrupting and frustrating to users, and may not meet the networking needs of the users.

Thus, the edge-based connectivity failover system 100 may operate to provide continuous network connectivity, thus preventing an interruption in service and a communication session, by creating a virtual overlay network over a plurality of communication network channels. According to an example, the overlay network may include a primary overlay tunnel 124 created between a first interface 134 on the SD-WAN base 102 and an interface 136 for the SD-WAN remote 104 and a secondary overlay tunnel 126 created between a second interface 138 on the SD-WAN base 102 and the interface 136 for the SD-WAN remote 104. For example, redundancy may be provided at the SD-WAN base 102. The primary overlay tunnel 124 may be configured through the primary access network 114 and the secondary overlay tunnel 126 may be configured through the secondary access network 120. In some examples, the primary overlay tunnel 124 and the secondary overlay tunnel 126 are IP Security (IPSec) tunnels. As mentioned above, the SD-WAN remote 104 may be deployed at an edge location of the network 108. According to an example, the interface 136 for the SD-WAN remote 104 may be an interface of the VM 130 hosting the SD-WAN remote 104.

In some examples, the network 108 may be a Tier 2 network. In other examples, the network 108 may be a Tier 3 network. For example, the network 108 may peer with a plurality of other networks 118 and may include numerous edge devices 132 geographically distributed in various locations throughout the network 108. Accordingly, the edge devices 132, and thus the SD-WAN remote 104, may not only be a highly secure device, but may further have resilient Internet connectivity. Moreover, the VM 130 and SD-WAN remote 104 may be instantiated on an edge device 132 geographically close to the client premises 106 to minimize latency associated with communicating with the SD-WAN remote 104 via the primary overlay tunnel 124 and the secondary overlay tunnel 126.

The SD-WAN remote 104, for example, may be operative or configured to transmit a default route to the SD-WAN base 102 across both overlay tunnels, wherein the default route advertised to the SD-WAN base 102 over the primary overlay tunnel 124 may be weighted differently so that it may be preferred over the secondary overlay tunnel 126. Thus, the SD-WAN base 102 may be configured to normally direct outbound traffic from the client premises 106 to the SD-WAN remote 104 over the primary access network 114 using the primary overlay tunnel 124. For example, when packets are transmitted by a device 110 directed to an endpoint device 112, the SD-WAN base 102 may receive the packets from the device 110 and encapsulate the packets in an IP Security (IPSec) or other tunneling protocol packet header comprising a destination address of the IP address of the interface 136 of the SD-WAN remote 104 and a source address of the IP address of the first interface 134 of the SD-WAN base 102. The SD-WAN base 102 may then direct the traffic to the SD-WAN remote 104 based on the advertised route associated with the primary overlay tunnel 124.

According to an example, the SD-WAN remote 104 may receive the traffic via its interface 136, perform network address translation (NAT), and then direct the traffic, via the same interface 136, over another link 140 through one or more other networks 118 to its target destination (e.g., endpoint device 112). In performing NAT, the SD-WAN remote 104 may translate the source address of the traffic from the IP address associated with the first interface 134 on the SD-WAN base 102 (i.e., primary communication transport interface) to the IP address of the interface 136 of the SD-WAN remote 104. The SD-WAN remote 104 may further operate to keep track of NAT translations.

According to an example, the SD-WAN 104 may further operate to receive inbound traffic from the endpoint device 112. For example, the SD-WAN remote 104 may receive the inbound traffic via its interface 136, perform NAT to translate the destination address from the IP address of the SD-WAN remote interface 136 to the IP address of the first interface 134 of the SD-WAN base 102. The SD-WAN remote 104 may then send the traffic to the SD-WAN base 102 based on a route advertised by the SD-WAN base 102 associated with the primary overlay tunnel 124. For example, the SD-WAN base 102 may be configured to advertise a default route for the primary overlay tunnel 124 and a default route for the secondary overlay tunnel 126, wherein the default route for the primary overlay tunnel 124 may be weighted such that it may be preferred over the secondary overlay tunnel 126. The SD-WAN base 102 may then receive the inbound traffic and direct the traffic to the device 110. Accordingly, an application operating on the device 110 may have an established communication with the endpoint device 112 via the primary overlay tunnel 124 to the SD-WAN remote 104 and another link 140 to the endpoint device 112.

According to an aspect, the SD-WAN base 102 may be further operative or configured to continually send test packets to the SD-WAN remote 104 along the primary overlay tunnel 124 to test the primary overlay tunnel 124 connection according to one or a combination of service level agreement (SLA) parameters (e.g., service delivery and performance parameters that may be agreed upon between the customer and the network service provider). For example, the parameters may include parameters corresponding to packet loss, latency, and/or jitter that may be indicators of service degradation. The test packet results may be evaluated against a set of failover criteria. For example, the failover criteria may correspond with a level of service degradation that may be determined as a failover event. Test settings (e.g., packet sizes, frequency of pings, duration, acceptable delay), parameters that may be evaluated, and the failover criteria (e.g., a specified acceptable range of SLA parameters) may be defined in the template and/or other configuration information provided by the controller 128 during configuration of the SD-WAN base 102. In some examples, the test settings, parameters, and/or failover criteria may be configurable by the user and/or the service provider.

When the test packet results satisfy the failover criteria, the SD-WAN base 102 may determine that a failover event has occurred. When a failover event is determined, the SD-WAN base 102 may operate to direct outbound traffic to the SD-WAN remote 104 via the secondary overlay tunnel 126. For example, when a failover event is detected, the SD-WAN base 102 may be configured to utilize the second interface 138 and the secondary communication transport 122 to transmit the outbound traffic over the secondary overlay tunnel 126. In some examples, the SD-WAN base 102 may send the traffic over the default route advertised by the SD-WAN remote 104 over the secondary overlay tunnel 126.

The SD-WAN remote 104 may receive the outbound traffic at its interface 136 via the secondary overlay tunnel 126 and perform NAT, similarly as when the outbound traffic was received via the primary overlay tunnel 126. For example, the SD-WAN remote 104 may translate the source address of the traffic from the IP address associated with the second interface 138 on the SD-WAN base 102 (i.e., secondary communication transport interface) to the IP address of the interface 136 of the SD-WAN remote 104, and then direct the traffic to its target destination (e.g., endpoint device 112) via the same interface 136. That is, the traffic sent to the endpoint device 112 via the link 140 between the SD-WAN remote 104 and the endpoint device 112 may include the same source IP address, regardless of whether the traffic was transmitted to the SD-WAN remote 104 over the primary overlay tunnel 124 or the secondary overlay tunnel 126. Thus, even when a failover event occurs, the session between the device 110 at the client premises 106 and the endpoint device 112 may remain stable. The SD-WAN remote 104 may further operate to direct inbound traffic received from the endpoint device 112 to the SD-WAN base 102 via the secondary overlay tunnel 126. For example, the SD-WAN remote 104 may perform NAT to translate the destination address from the IP address of the SD-WAN remote interface 136 to the IP address of the second interface 138 of the SD-WAN base 102 and send the traffic to the SD-WAN base 102 based on the route advertised by the SD-WAN base 102 associated with the secondary overlay tunnel 126. The SD-WAN base 102 may then receive the inbound traffic and direct the traffic to the device 110. Accordingly, the application operating on the device 110 may have a continuous and stable connection and maintain sessions regardless of which overlay tunnel is being used.

In some examples, the SD-WAN base 102 may further operate to continue to send test packets to the SD-WAN remote 104 along the primary overlay tunnel 124. For example, the SD-WAN base 102 may operate to determine whether one or a combination of parameters (e.g., packet loss, latency, and/or jitter) associated with the primary overlay tunnel 124 connection may continue to satisfy the failover criteria. For example, when the test packet results continue to satisfy the failover criteria, the outbound traffic may continue to be directed to the SD-WAN remote 104 via the secondary overlay tunnel 126.

In some examples, when network connectivity on the primary overlay tunnel 124 may be determined to be reestablished, the SD-WAN base 102 may be configured to move the outbound traffic back to the primary overlay tunnel 124, such that the traffic can be transported over the primary access network 114. In some examples, various conditions may need to be satisfied prior to moving traffic back to the primary overlay tunnel 124. One example condition may include a minimum time period that the connection along the primary overlay tunnel 124 may need to be stable. For example, this may prevent sporadic switching between the tunnels from occurring. In some examples, the various conditions may be configurable by the user. According to an aspect, the movement of the traffic between the primary overlay tunnel 124 and the secondary overlay tunnel 126 based on an evaluation of the connection between the interfaces (i.e., the first interface 134 and the second interface 138) of the SD-WAN base 102 and the interface 136 of the SD-WAN remote 104 may enable the connection between the SD-WAN remote 104 to be maintained when a failover event occurs.

In some examples, the SD-WAN base 102 may operate to continually test both the primary overlay tunnel 124 and the secondary overlay tunnel 126 and to determine a preferred overlay tunnel based on test packet evaluation results. In one example, the test packets received via the primary overlay tunnel 124 and test packets received via the secondary overlay tunnel 126 may be evaluated based on packet loss, latency, and/or jitter, and a determination may be made as to which overlay tunnel may provide better application performance. Accordingly, the SD-WAN base 102 may be configured to direct outbound traffic along the better performing overlay tunnel. In some examples, the SD-WAN base 102 may be configured to direct some traffic over the primary overlay tunnel 124 and other traffic over the secondary overlay tunnel 126. For example, a determination may be made as to which traffic to direct over which tunnel based on maintaining one or a combination of SLA parameters that may correspond to packet loss, latency, and/or jitter. As another example, the determination may be made based at least in part on a data cap, throttling, or other restriction or condition associated with the primary overlay tunnel 124 and/or the secondary overlay tunnel 126.

In some examples, the SD-WAN base 102 may further operate to revert to performing local NAT and split tunneling to route traffic through a separate tunnel 142 on the network 108. For example, if a situation should occur where the SD-WAN remote 104 fails and/or both the primary overlay tunnel 124 and the secondary overlay tunnel 126 fail or otherwise have service degradation that meets failover criteria, the SD-WAN base 102 may be configured to move traffic to the other tunnel 142 to direct traffic to the endpoint device 112 for continued network connectivity. This may be performed, for example, as a last resort.

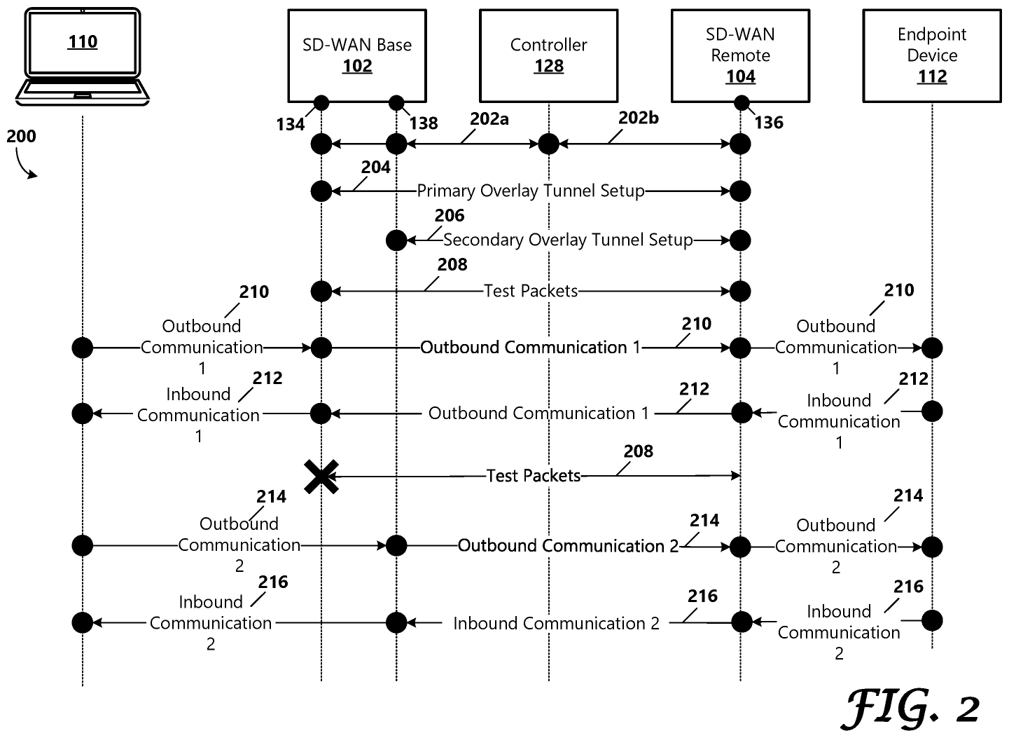

FIG. 2 is a sequence diagram that illustrates an example sequence of communications 200 that may be exchanged between various components described above that may operate in the edge-based connectivity failover system 100. For example, a first set of communications may include configuration information 202a that may be communicated between the controller 128 and an SD-WAN base 102 and a second set of communications may include configuration information 202b that may be communicated between the controller 128 and an SD-WAN remote 104 for establishing a primary overlay tunnel 124 and a secondary overlay tunnel 126 between the SD-WAN base 102 and the SD-WAN remote 104. As described above, the SD-WAN remote 104 may be deployed on a VM 130 that may be instantiated on an edge device 132 in the network 108. For example, the edge device 132 may be at an edge location geographically near the client premises 106 such that latency may be minimized. The configuration information 202a,b may include one or more templates and other information that may be needed to establish secure overlay tunnels that may support secure communication of packets of information between the SD-WAN base 102 and the SD-WAN remote 104. For example, the configuration information 202a,b may include encryption and authentication algorithms that the SD-WAN base 102 may be configured to use for the overlay tunnel connections, for example, via a first interface 134 connected to a primary access network 114 and a second interface 138 connected to a secondary access network 120.

Further, a set of communications 204 may be exchanged between the SD-WAN base 102 and the SD-WAN remote 104 to establish the primary overlay tunnel 124 between the first interface 134 on the SD-WAN base 102 and the SD-WAN remote interface 136. For example, the primary overlay tunnel 124 may be configured to access the network 108 via a primary access network 114. Additionally, another set of communications 206 may be exchanged between the SD-WAN base 102 and the SD-WAN remote 104 to establish the secondary overlay tunnel 126 between the second interface 138 on the SD-WAN base 102 and the SD-WAN remote interface 136. For example, the secondary overlay tunnel 126 may be configured to access the network 108 via a secondary access network 120. In some examples, the set of communications 204,206 may be initiated by the SD-WAN base 102. In other examples, the set of communications 204,206 may be initiated by the SD-WAN remote 104.

According to an aspect, the SD-WAN base 102 may recurrently transmit test packets 208 to the SD-WAN remote 104 over at least one of the overlay tunnels. For example, the SD-WAN base 102 may be configured to test the primary overlay tunnel 124 connection according to one or a combination of SLA parameters for a failover event (e.g., when one or a combination of SLA parameters are not within a specified range based on configuration settings). For example, when test packet results 208 are within the specified range, the SD-WAN base 102 may be configured to communicate over the primary overlay tunnel 124 by default.

As shown in FIG. 2, a first outbound communication 210 in a communication session between a device 110 at the client premises 106 and a network-connected endpoint device 112 may be sent from the device 110 at the client premises 106 to the SD-WAN base 102. The SD-WAN base 102 may encapsulate the first outbound communication 210 with a header including the IP address of the interface 136 of the SD-WAN remote 104 as the destination and the IP address of the first interface 134 of the SD-WAN base 102 as the source, and then may transmit the communication to the SD-WAN remote 104 over the primary overlay tunnel 124. The SD-WAN remote 104 may perform NAT to translate the source of the first outbound communication 210 from the IP address of the first interface 134 of the SD-WAN base 102 to the IP address of the interface 136 of the SD-WAN remote 104, and then may transmit the first outbound communication 210 (e.g., over another network 118) to be delivered to the endpoint device 112.

In some examples and as shown in FIG. 2, a first inbound communication 212 in the communication session may be sent from the endpoint device 112 to the SD-WAN remote 104. The SD-WAN remote 104 may receive the first inbound communication 212, translate the destination of the first inbound communication 212 from the IP address of the SD-WAN remote interface 136 to the IP address of the first interface 134 of the SD-WAN base 102, and then may transmit the first inbound communication 212 over the network 108 and the primary access network 114 via the primary overlay tunnel 124 to the SD-WAN base 102 to be delivered to the endpoint device 112.

As illustrated, the SD-WAN base 102 may continue to send test packets 208 to the SD-WAN remote 104. For example, when test packet results indicate a failover event (e.g., one or a combination of SLA parameters are not within a specified range), the SD-WAN base 102 may move communications to the second interface 138. For example and as shown, when a second outbound communication 214 is transmitted by the device 110 in the communication session, the SD-WAN base 102 may encapsulate the second outbound communication 214 with a header including the IP address of the interface 136 of the SD-WAN remote 104 as the destination and the IP address of the second interface 138 of the SD-WAN base 102 as the source, and then may transmit the communication to the SD-WAN remote 104 over the secondary overlay tunnel 126. The SD-WAN remote 104 may perform NAT to translate the source of the second outbound communication 214 from the IP address of the second interface 138 of the SD-WAN base 102 to the IP address of the interface 136 of the SD-WAN remote 104, and then may transmit the second outbound communication 214, e.g., over another network 118 to be delivered to the endpoint device 112. According to an aspect, even when an outage of network connectivity occurs in primary access network 114, the communication session may persist, without interruption, over the secondary overlay tunnel 126.

Further, in some examples, a second inbound communication 216 in the communication session may be sent from the endpoint device 112 to the SD-WAN remote 104. The SD-WAN remote 104 may receive the second inbound communication 216, translate the destination of the second inbound communication 216 from the IP address of the SD-WAN remote interface 136 to the IP address of the second interface 138 of the SD-WAN base 102, and then may transmit the second inbound communication 216 over the network 108 and the secondary access network 120 via the secondary overlay tunnel 126 to the SD-WAN base 102 to be delivered to the endpoint device 112.

In some examples, the SD-WAN base 102 may continue to send test packets 208 to determine whether conditions may be satisfied to move network traffic back to the first interface 134. In some implementations, the SD-WAN base 102 may be configured to pause sending test packets 208 for a time period after a failover event has occurred. When one or a combination of SLA parameters associated with the primary overlay tunnel 124 are determined to be within a specified range over a specified period and, in some examples, after the time period, the SD-WAN base 102 may switch transmissions back to the first interface 134 and then may transmit a next outbound communication to the SD-WAN remote 104 over the primary overlay tunnel 124.

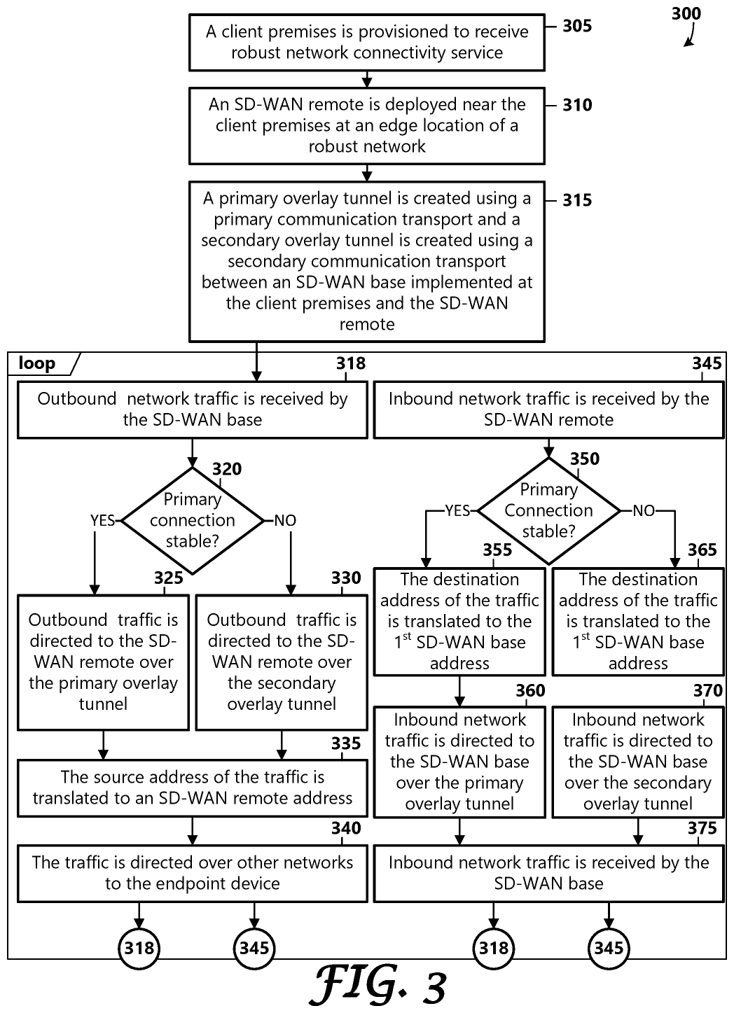

FIG. 3 is a flowchart illustrating general operations of an example method of providing robust network connectivity according to an embodiment. In some examples, the method 300 may be implemented by the edge-based connectivity failover system 100 shown and described with respect to FIG. 1. The method 300 may begin at OPERATION 305, where a client premises 106 may be provisioned to receive robust network connectivity service. In some examples, robust network connectivity service may be an option that a customer may select to implement at the client premises 106. For example, the customer may need a consistent and reliable network connection to maintain online communication sessions, such as real time communication sessions, even when network connectivity to the client premises 106 may be susceptible to service interruptions and outages. According to some examples, when the client premises 106 is provisioned to receive robust network connectivity service, a SD-WAN base 102 may be provided to the customer for installation at the client premises 106. The SD-WAN base 102, for example, may be connected to a primary access network 114 that may provide network connectivity and service between the client premises 106 and a robust network, such as network 108. The SD-WAN base 102 may further be connected to a secondary access network 120 that may provide connectivity to the network 108. In some examples, the SD-WAN base 102 may communicate with a controller 128 during a setup operation of the SD-WAN base 102. For example, the SD-WAN base 102 may communicate various connection, authentication, and encryption information to the controller 128 for configuring a primary overlay tunnel 124 using a first interface 134 and a secondary overlay tunnel 126 using a second interface 138. In some examples, the SD-WAN base 102 may authenticate itself with the controller 128.

At OPERATION 310, an SD-WAN remote 104 may be deployed on a VM 130 that may be instantiated on an edge device 132 in the network 108. In some examples, the VM 130 may be created and the SD-WAN remote 104 may be deployed on the VM 130 automatically. For example, an edge device 132 geographically and/or logically near the client premises 106 may be selected to host the VM 130 and SD-WAN remote 104 such that latency may be minimized. In some examples, the controller 128 may send configuration information to the VM 130 for establishing the SD-WAN remote 104. In some examples, a certificate may be requested for installation on the SD-WAN remote 104, and the certificate information may be provided to the controller 128. When the SD-WAN 104 is established, the SD-WAN remote 104 may authenticate itself with the controller 128.

At OPERATION 315, after authenticating the SD-WAN base 102 and the SD-WAN remote 104, the controller 128 may send configuration information to the SD-WAN base 102 and the SD-WAN remote 104, and the SD-WAN base 102 and the SD-WAN remote 104 may be enabled to communicate via the primary overlay tunnel 124 and the secondary overlay tunnel 126. According to examples, the SD-WAN remote 104 may be configured to advertise a default route for the primary overlay tunnel 124 and a default route for the secondary overlay tunnel 126 to the SD-WAN base 102, wherein the default route for the primary overlay tunnel 124 may be weighted such that it may be preferred over the secondary overlay tunnel 126.

At OPERATION 318, outgoing network traffic, such as the first outbound communication 210 described above, may be received by the SD-WAN base 102. For example, a device 110 connected to the SD-WAN base 102 may transmit packets to the SD-WAN base 102 to send over the network 108 and, e.g., other networks 118, to an endpoint device 112. In some examples, the SD-WAN base 102 may be configured to direct outgoing traffic to the SD-WAN remote 104 over the primary overlay tunnel 124. Additionally, the SD-WAN base 102 may be configured to recurrently send test packets to the SD-WAN remote 104 over the overlay network to determine (DECISION OPERATION 320) whether the connection is stable.

For example, the determination may be based on an evaluation of one or a combination of test result parameters corresponding to packet loss, latency, and/or jitter. The test result parameters may be evaluated against a set of failover criteria, which may specify whether the test result parameters indicate service degradation or meet an acceptable range of SLA parameters. When a determination is made that the primary overlay tunnel 124 is stable or that a failure event has not occurred, at OPERATION 325, the outgoing network traffic may be directed to the SD-WAN remote 104 over the primary overlay tunnel 124. For example, the SD-WAN base 102 may operate by default to use the IP address of the first interface 134 as the source address to direct the outgoing traffic over the primary overlay tunnel 124.

When a determination is made that the primary overlay tunnel 124 is not stable or that a failure event has occurred, at OPERATION 330, the outgoing network traffic may be directed to the SD-WAN remote 104 over the secondary overlay tunnel 126. For example, the SD-WAN base 102 may operate to use the IP address of the second interface 138 as the source address to direct the outgoing traffic over the secondary overlay tunnel 126.

At OPERATION 335, the outgoing traffic may be received by the SD-WAN remote 104 and NAT may be performed to translate the source address to the IP address of the SD-WAN remote interface 136. For example, when the primary overlay tunnel 124 is used, the SD-WAN remote 104 may translate the source address from the IP address of the first interface 134 to the IP address of the SD-WAN remote interface 136; and when the secondary overlay tunnel 126 is used, such as when a failover event is determined, the SD-WAN remote 104 may translate the source address from the IP address of the second interface 138 to the IP address of the SD-WAN remote interface 136. Accordingly, regardless of whether the traffic is sent over the primary overlay tunnel 124 or whether the primary overlay tunnel fails and the secondary overlay tunnel 126 is used, network connectivity and the communication session is maintained.

At OPERATION 340, the outgoing traffic may be transmitted over another link 140 through the one or more other networks 118 to its target destination (e.g., endpoint device 112).

In some examples, the method 300 may return to OPERATION 318. For example, another outgoing communication in the communication session may be sent by the device 110 to the SD-WAN base 102. Or, in other examples, the method 300 may proceed to OPERATION 345, where incoming network traffic sent from the endpoint device 112 may be received by the SD-WAN remote 104.

In some examples, the SD-WAN base 102 may be continue to send test packets to the SD-WAN remote 104 over the overlay network to determine (DECISION OPERATION 350) whether the primary connection is stable. For example, when a determination is made that the primary overlay tunnel 124 is stable or that a failure event has not occurred, at OPERATION 355, the destination address may be translated from the SD-WAN remote interface 136 to the IP address of the first interface 134 as the source address, and at OPERATION 360, the incoming network traffic may be directed to the SD-WAN base 102 over the primary overlay tunnel 124 according to a default route advertised by the SD-WAN base 102 over the primary overlay tunnel 124.

In other examples, when a determination is made that the primary overlay tunnel 124 is not stable or that a failure event has occurred, the SD-WAN base 102 may be configured to switch interfaces. Accordingly, the default address advertised by the SD-WAN base 102 may be associated with the secondary overlay tunnel 126, and at OPERATION 365, the destination address may be translated from the SD-WAN remote interface 136 to the IP address of the second interface 138. At OPERATION 370, the incoming network traffic may be directed to the SD-WAN base 102 over the secondary overlay tunnel 126 according to a default route advertised by the SD-WAN base 102 over the secondary overlay tunnel 126.

At OPERATION 375, the incoming traffic may be received by the SD-WAN base 102, and the traffic may be delivered to the device 110 in an uninterrupted communication session. In some examples, the method 300 may return to OPERATION 318. For example, another outgoing communication in the communication session may be sent by the device 110 to the SD-WAN base 102. Or, in other examples, the method 300 may return to OPERATION 345, where another incoming communication in the communication session may be received by the SD-WAN remote 104. OPERATIONS 318 and/or 345 through 375 may continue until the session ends.

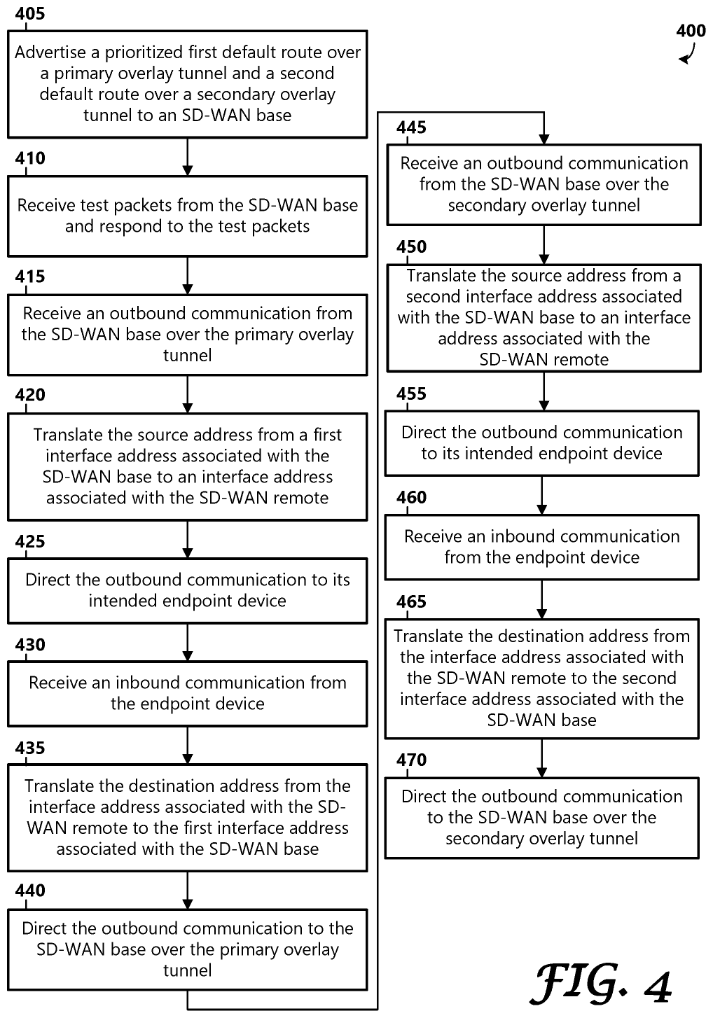

FIG. 4 is a flowchart illustrating general operations of another example method of providing robust network connectivity according to an embodiment. In some examples, the method 400 may be implemented by the SD-WAN remote 104 shown and described with respect to FIG. 1. For example, a plurality of overlay tunnels may be configured between the SD-WAN remote 104 and a SD-WAN base 102. In the example method described in FIG. 4, the overlay tunnels include a primary overlay tunnel 124 utilizing a primary access network 114 and a secondary overlay tunnel 126 utilizing a secondary access network 120. The method 400 may begin at OPERATION 405, where a first default route to the SD-WAN base 102 may be prioritized and advertised over the primary overlay tunnel 124 and a second default route may be advertised over the secondary overlay tunnel 126.

At OPERATION 410, test packets may be received and responded to. For example, test packets may be repetitively sent by the SD-WAN base 102 to test the connection of the primary overlay tunnel 124 throughout the method 400.

At OPERATION 415, an outgoing communication 210 may be received over the primary overlay tunnel 124. For example, the outgoing communication 210 may be encapsulated with an IP header directing the outgoing communication 210 to the SD-WAN remote 104.

At OPERATION 420, the IP header may be stripped off the outgoing communication 210 and the underlying source address may be translated from the SD-WAN base associated IP address to an IP address associated with the SD-WAN remote 104 (e.g., VM 130 interface 136).

At OPERATION 425, the outgoing communication 210 may be transmitted, e.g., to another network 118 over another link 140 for delivery to an intended endpoint device 112.

At OPERATION 430, an incoming communication 212 in the communication session may be received via the other link 140.

At OPERATION 435, the destination address may be translated from the IP address associated with the SD-WAN remote 104 to the IP address associated with the SD-WAN base 102. For example, the IP address associated with the SD-WAN base 102 may be the IP address of the first interface 134, which may be connected to the primary overlay tunnel 124.

At OPERATION 440, the incoming communication 212 may be directed to the SD-WAN base 102 over the primary overlay tunnel 124 based on a default route advertised by the SD-WAN base 102 over the primary overlay tunnel 124.

At OPERATION 445, a second outgoing communication 214 from the SD-WAN base 102 may be received, wherein the second outgoing communication 214 may be received via the secondary overlay tunnel 126. For example, the SD-WAN base 102 may make a determination that the primary overlay tunnel 124 may not be stable or that a failure event has occurred. Accordingly, the SD-WAN base 102 may be configured to switch interfaces.

At OPERATION 450, like at OPERATION 420, the IP header may be stripped off the second outgoing communication 214 and the underlying source address may be translated from the SD-WAN base (e.g., IP address of the second interface 138) to the IP address associated with the SD-WAN remote 104 (e.g., VM 130 interface 136).

At OPERATION 455, the second outgoing communication 214 may be transmitted over the other link 140 for delivery to the intended endpoint device 112.

At OPERATION 460, another incoming communication 210 in the communication session may be received via the other link 140.

At OPERATION 465, the destination address may be translated from the IP address associated with the SD-WAN remote 104 to the IP address associated with the SD-WAN base 102. For example, the IP address associated with the SD-WAN base 102 may be the IP address of the second interface 138, which may be connected to the secondary overlay tunnel 126.

At OPERATION 470, the incoming communication 210 may be directed to the SD-WAN base 102 over the secondary overlay tunnel 126 based on a default route advertised by the SD-WAN base 102 over the secondary overlay tunnel 126.

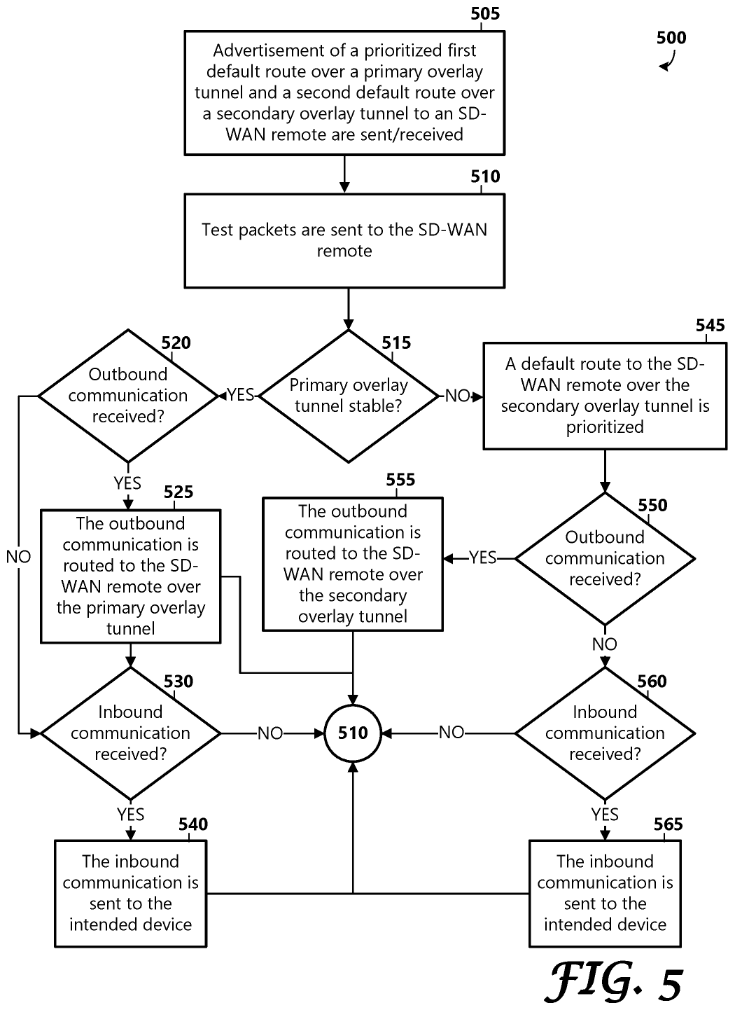

FIG. 5 is a flowchart illustrating general operations of another example method 500 of providing robust network connectivity according to an embodiment. In some examples, the method 500 may be implemented by the SD-WAN base 102 shown and described with respect to FIG. 1. For example, a plurality of overlay tunnels may be configured between the SD-WAN base 102 and a SD-WAN remote 104. In the example method 500 described in FIG. 5, the overlay tunnels include a primary overlay tunnel 124 utilizing a primary access network 114 and a secondary overlay tunnel 124 utilizing a secondary access network 120. In other examples, different types of transports and/or additional overlay tunnels may be configured and implemented. The method 500 may begin at OPERATION 505, where an advertisement of a first default route to the SD-WAN remote 104 may be received over the primary overlay tunnel 124 and another advertisement of a second default route to the SD-WAN remote 104 may be received over the secondary overlay tunnel 126, wherein the primary overlay tunnel 124 route may be weighted higher than the secondary overlay tunnel 126 route. For example, the SD-WAN base 102 may store the route information associated with the first default route and the second default route, including route preference information, in a routing table. The SD-WAN remote 104 may additionally store route information associated with a first default route over the primary overlay tunnel 124 and a second default route over the secondary overlay tunnel 126.

At OPERATION 510, test packets may be continually sent to the SD-WAN remote 104 for testing the connection(s) to the SD-WAN remote 104 for service failure or degradation of service that may meet criteria of a failover event. For example, at DECISION OPERATION 515, a determination may be made as to whether the primary overlay tunnel 124 is stable. When a determination that the primary overlay tunnel 124 is stable, the primary overlay tunnel 124 may continue to be used as the default route between the SD-WAN base 102 and the SD-WAN remote 104. For example, when an outbound communication 210 is received from a connected device 110 at DECISION OPERATION 520, the outbound communication 210 may be routed to the SD-WAN remote 104 over the default route (i.e., the primary overlay tunnel 124). For example, the SD-WAN base 102 may encapsulate the outbound communication 210 in an IP packet and forward the IP packet including the outbound communication 210 to the SD-WAN remote 104 based on routing information stored in the routing table in association with the first default route over the primary overlay tunnel 124.

Or, when an inbound communication 212 is received over the primary overlay tunnel 124 at DECISION OPERATION 530, the inbound communication 212 may be unencapsulated and sent to the connected device 110 at OPERATION 540. In examples, OPERATIONS 530 and 540 may occur separately from (and not dependent upon) OPERATIONS 520 and 525.

According to another example, if, at DECISION OPERATION 515, a determination is made that the primary overlay tunnel 124 is not stable (e.g., an evaluation of the test packets indicate that the primary overlay tunnel 124 has failed or has a level of service degradation that meets criteria of a failover event), at OPERATION 545, the default route advertised over the secondary overlay tunnel 126 may be prioritized. In some examples, the first route over the primary overlay tunnel 124 may be deprioritized for a minimum time period. For example, the second route advertised by the SD-WAN remote 104 over the secondary overlay tunnel 126 may be prioritized and used as the default route between the SD-WAN base 102 and the SD-WAN remote 104.

When an outbound communication 210 is received from a connected device 110 at DECISION OPERATION 550, at OPERATION 555, the outbound communication 210 may be routed to the SD-WAN remote 104 over the new default route (i.e., the secondary overlay tunnel 126). For example, the SD-WAN base 102 may encapsulate the outbound communication 210 in an IP packet and forward the IP packet including the outbound communication 210 to the SD-WAN remote 104 based on routing information stored in the routing table in association with the second default route over the secondary overlay tunnel 126.

Or, when an inbound communication 212 is received over the secondary overlay tunnel 126 at DECISION OPERATION 560, the inbound communication 212 may be decapsulated and sent to the connected device 110 at OPERATION 565. In examples, OPERATIONS 560 and 565 may occur separately from (and not dependent upon) OPERATIONS 545 and 550.

As shown, OPERATIONS 525, 530, 555, 560, and 565 may loop back to OPERATION 510, where test packets may continue to be sent and evaluated for determining whether the primary overlay tunnel 124 may be stable. In some examples, when traffic has been moved to the secondary overlay tunnel 126, after a minimum time period that the SD-WAN base 102 may be configured to wait until a stable connection may be determined, the primary overlay tunnel 124 may be determined (DECISION OPERATION 515) to be operational and one or a combination of SLA parameters may be determined to be within a specified range. Thus, the first default route advertised by the SD-WAN remote 104 over the primary overlay tunnel 124 may be selected for forwarding outbound communications 210 that may be received at DECISION OPERATION 520 and for receiving inbound communications 212 that may be received at DECISION OPERATION 530.

FIG. 6 is a system diagram of a computing device 600 according to an example. The computing device 600, or various components and systems of the computing device 600, may be integrated or associated with the SD-WAN remote, the SD-WAN base, the controller, the device 110, or the endpoint device 112. As shown in FIG. 6, the physical components (e.g., hardware) of the computing device 600 are illustrated and these physical components may be used to practice the various aspects of the present disclosure.

The computing device 600 may include at least one processing unit 610 and a system memory 620. The system memory 620 may include, but is not limited to, volatile storage (e.g., random access memory), non-volatile storage (e.g., read-only memory), flash memory, or any combination of such memories. The system memory 620 may also include an operating system 630 that controls the operation of the computing device 600 and one or more program modules 640. The program modules 640 may be responsible for performing one more of the operations of the methods described above for providing robust network connectivity. A number of different program modules and data files may be stored in the system memory 620. While executing on the processing unit 610, the program modules 640 may perform the various processes described above.

The computing device 600 may also have additional features or functionality. For example, the computing device 600 may include additional data storage devices (e.g., removable and/or non-removable storage devices) such as, for example, magnetic disks, optical disks, or tape. These additional storage devices are labeled as a removable storage 660 and a non-removable storage 670.

Examples of the disclosure may also be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 6 may be integrated onto a single integrated circuit. Such a SOC device may include one or more processing units, graphics units, communications units, system virtualization units and various application functionality all of which are integrated (or “burned”) onto the chip substrate as a single integrated circuit.

When operating via a SOC, the functionality, described herein, may be operated via application-specific logic integrated with other components of the computing device 600 on the single integrated circuit (chip). The disclosure may also be practiced using other technologies capable of performing logical operations such as, for example, AND, OR, and NOT, including but not limited to mechanical, optical, fluidic, and quantum technologies.

The computing device 600 may include one or more communication systems 680 that enable the computing device 600 to communicate with other computing devices 695 such as, for example, routing engines, gateways, signings systems and the like. Examples of communication systems 680 include, but are not limited to, wireless communications, wired communications, cellular communications, radio frequency (RF) transmitter, receiver, and/or transceiver circuitry, a Controller Area Network (CAN) bus, a universal serial bus (USB), parallel, serial ports, etc.

The computing device 600 may also have one or more input devices and/or one or more output devices shown as input/output devices 690. These input/output devices 690 may include a keyboard, a sound or voice input device, haptic devices, a touch, force and/or swipe input device, a display, speakers, etc. The aforementioned devices are examples and others may be used.

The term computer-readable media as used herein may include computer storage media. Computer storage media may include volatile and nonvolatile, removable and non-removable media implemented in any method or technology for storage of information, such as computer readable instructions, data structures, or program modules.

The system memory 620, the removable storage 660, and the non-removable storage 670 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system for providing robust network connectivity, the system comprising a software-defined wide area network (SD-WAN) remote implemented at an edge location of a network, wherein the SD-WAN remote is operative to:
communicate with an SD-WAN base implemented at a client premises over a first overlay tunnel created via a first access network;
communicate with the SD-WAN base over a second overlay tunnel created via a second access network, wherein the first overlay tunnel is prioritized over the second overlay tunnel by default;
receive a first outbound communication from the SD-WAN base over the first overlay tunnel;
translate a source address of the first outbound communication from a first Internet protocol (IP) address of the SD-WAN base to an IP address of the SD-WAN remote;
direct the first outbound communication to a destination device;
receive a first inbound communication from the destination device;
translate a destination address of the first inbound communication from the IP address of the SD-WAN remote to the first IP address of the SD-WAN base;
direct the first inbound communication to the SD-WAN base over the first overlay tunnel; and
after a failover event is determined in association with the first overlay tunnel:
receive a second outbound communication from the SD-WAN base over the second overlay tunnel;
translate a source address of the second outbound communication from a second IP address of the SD-WAN base to the IP address of the SD-WAN remote; and
direct the second outbound communication to the destination device.

2. The system of claim 1, wherein the first overlay tunnel and the second overlay tunnel are IP security (IPSec) tunnels.

3. The system of claim 1, wherein:
the first outbound communication and the second outbound communication are encapsulated in an IP packet including an IP header; and
the SD-WAN remote is further operative to decapsulate the first outbound communication and the second outbound communication prior to the translations of the source address.

4. The system of claim 1, wherein the SD-WAN remote is configured to operate on a virtual machine hosted on an edge device in the network.

5. The system of claim 4, wherein the edge device is one of a plurality of edge devices in the network and, among the plurality of edge devices, is located geographically closest to the SD-WAN base.

6. The system of claim 1, wherein the failover event is based on a determination made by the SD-WAN base in response to an evaluation of test packets transmitted to the SD-WAN remote against a set of failover criteria.

7. The system of claim 6, wherein the failover event is in association with the first overlay tunnel.

8. The system of claim 6, wherein the failover event is determined when one or a combination of service level agreement (SLA) parameters are outside of a specific range, the SLA parameters including:
packet loss;
latency; and
jitter.

9. The system of claim 1, wherein the SD-WAN remote is further operative to:
receive a second inbound communication from the destination device;
translate a destination address of the second inbound communication from the IP address of the SD-WAN remote to the second IP address of the SD-WAN base; and
direct the second inbound communication to the SD-WAN base over the second overlay tunnel.

10. The system of claim 9, wherein when, after the failover event, the first overlay tunnel is determined to be stable, the SD-WAN remote is further operative to:
receive a third outbound communication from the SD-WAN base over the first overlay tunnel;
translate a source address of the third outbound communication from the first IP address of the SD-WAN base to the IP address of the SD-WAN remote; and
direct the third outbound communication to the destination device.

11. The system of claim 1, wherein in translating the source address of the first outbound communication from the first IP address of the SD-WAN base to the IP address of the SD-WAN remote, the SD-WAN remote is operative to translate the source address from the IP address of a first interface of the SD-WAN base, wherein the first interface is connected to an interface of the SD-WAN remote via the first overlay tunnel.

12. The system of claim 1, wherein in translating the source address of the second outbound communication from the second IP address of the SD-WAN base to the IP address of the SD-WAN remote, the SD-WAN remote is operative to translate the source address from the IP address of a second interface of the SD-WAN base, wherein the second interface is connected to an interface of the SD-WAN remote via the second overlay tunnel.

13. A method for providing robust network connectivity, comprising:
establishing a first overlay tunnel over a first communication transport with a software-defined wide area network (SD-WAN) base;
establishing a second overlay tunnel over a second communication transport with the SD-WAN base;
advertising the first overlay tunnel with a higher priority than the second overlay tunnel by default;
receiving a first outbound communication from the SD-WAN base over the first overlay tunnel;
translating a source address of the first outbound communication from a first Internet protocol (IP) address of the SD-WAN base to an IP address of the SD-WAN remote;
directing the first outbound communication to a destination device;
receiving a first inbound communication from the destination device;
translating a destination address of the first inbound communication from the IP address of the SD-WAN remote to the first IP address of the SD-WAN base;
directing the first inbound communication to the SD-WAN base over the first overlay tunnel; and
after a failover event is determined in association with the first overlay tunnel:
receiving a second outbound communication from the SD-WAN base over the second overlay tunnel;
translating a source address of the second outbound communication from a second IP address of the SD-WAN base to the IP address of the SD-WAN remote; and
directing the second outbound communication to the destination device.

14. The method of claim 13, further comprising:
receiving a second inbound communication from the destination device;
translating a destination address of the second inbound communication from the IP address of the SD-WAN remote to the second IP address of the SD-WAN base; and
directing the second inbound communication to the SD-WAN base over the second overlay tunnel.

15. The method of claim 14, further comprising:
when, after the failover event, the first overlay tunnel is determined to be stable, receiving a third outbound communication from the SD-WAN base over the first overlay tunnel;
translating a source address of the third outbound communication from the first IP address of the SD-WAN base to the IP address of the SD-WAN remote; and
directing the third outbound communication to the destination device.

16. The method of claim 13, wherein:
translating the source address of the first outbound communication from the first IP address of the SD-WAN base to the IP address of the SD-WAN remote comprises translating the source address from the IP address of a first interface of the SD-WAN base, wherein the first interface is connected to an interface of the SD-WAN remote via the first overlay tunnel; and
translating the source address of the second outbound communication from the second IP address of the SD-WAN base to the IP address of the SD-WAN remote comprises translating the source address from the IP address of a second interface of the SD-WAN base, wherein the second interface is connected to an interface of the SD-WAN remote via the second overlay tunnel.

17. The method of claim 13, wherein a session is established between the SD-WAN base and the destination device prior to the failover event and continues after the failover event.

18. A system for providing robust network connectivity, the system comprising a software-defined wide area network (SD-WAN) base, wherein the SD-WAN base is operative to:
establish a first overlay tunnel created over a first communication transport with an SD-WAN remote implemented an edge location of a network;
establish a second overlay tunnel created over a second communication transport with the SD-WAN remote, wherein the first overlay tunnel is prioritized over the second overlay tunnel by default;
receive an outbound communication from a connected device;
determine whether the first overlay tunnel is stable or whether a failover event has occurred;
when the first overlay tunnel is determined to be stable:
forward the outbound communication to the SD-WAN remote over the first overlay tunnel; and
when a failover event is determined to have occurred:
forward the outbound communication to the SD-WAN remote over the second overlay tunnel.

19. The system of claim 18, wherein when a failover event is determined in association with the first overlay tunnel and the second overlay tunnel, the SD-WAN base is operative to perform split tunneling and forward the outbound communication to a destination device over another network route.

20. The system of claim 18, wherein determining whether the first overlay tunnel is stable or whether a failover event has occurred, the SD-WAN base is operative to:
continually send test packets to the SD-WAN remote; and
evaluate test packet results for determining whether one or a combination of service level agreement (SLA) parameters are outside of a specific range, the SLA parameters including:
packet loss;
latency; and
jitter.
